(19) United States
(12) Patent Application Publication
(10) Pub. No.: US 2013/0105270 A1
(43) Pub. Date: May 2, 2013

(54) LOAD TORQUE LOCK AND UNIT HAVING A LOAD TORQUE LOCK

(71) Applicants: Tarek Mili, Lauterbourg (DE); Holger Thoene, Rastatt (DE); Peter Kusserow, Buehl (DE); Peter Bohr, Karlsruhe (DE); Matthias Koerwer, Buehlertal (DE); Peter Schlosser, Buehl (DE)

(72) Inventors: Tarek Mili, Lauterbourg (DE); Holger Thoene, Rastatt (DE); Peter Kusserow, Buehl (DE); Peter Bohr, Karlsruhe (DE); Matthias Koerwer, Buehlertal (DE); Peter Schlosser, Buehl (DE)

(73) Assignee: ROBERT BOSCH GMBH, Stuttgart (DE)

(21) Appl. No.: 13/639,942

(22) PCT Filed: Apr. 1, 2011
(86) PCT No.: PCT/EP11/55075

§ 371 Date: Jan. 7, 2013

(30) Foreign Application Priority Data
Apr. 6, 2010 (DE) 10 2010 003 657.9

(51) Int. Cl. F16D 41/20

(52) U.S. Cl. CPC F16D 41/206
USPC 192/41 S

(57) ABSTRACT

The invention relates to a load torque lock (100) having a brake element (40) in particular designed as a torsional spring and frictionally interacting with a brake body (36) for locking a torque, and having a drive wheel preferably rotatably supported on an axle (17) and coupled to at least one pusher (20) interacting with the drive wheel (18) for transmitting a torque from a drive motor (12), wherein the pusher (20) comprises at least one contact region (32) to the brake element (40) by means of which a torque to be locked can be introduced into the braking body (36) by means of the brake element (40). According to the invention, the pusher (20) is made of a first pusher element (24) and a second pusher element (30) designed as a separate component, such that the first or second pusher element (24, 30) comprises at least one pusher dog (26) engaging in a penetration (27) in the drive wheel (18), such that both pusher elements (24, 30) are disposed on different sides of the drive wheel (18), with the exception of the at least one pusher dog (26).

### BACKGROUND OF THE INVENTION

The invention relates to a load torque lock.

Such a load torque lock is known from the applicant's subsequently published DE 10 2009 000 563 A1. The known load torque lock has a driver element which interacts via driver pins with a braking element in the form of a wrap spring. In this case, the driver pins engage with rotational angle play through recesses in a drive wheel which is driven by a drive motor via an external thread formed on the drive wheel, in order to pass on a torque for example to a downstream window opener mechanism or a seat adjustment mechanism. The load torque lock serves in this case to lock the drive wheel when a torque is introduced from the direction of the element to be driven. The greater the locking torque to be transmitted from the driver pins to the wrap spring, the greater the bending load or bending stress in the driver pins. As a result, given relatively large locking torques to be transmitted, said driver pins have either to have relatively large dimensions or to be manufactured from a relatively rigid or hard material.

### SUMMARY OF THE INVENTION

Proceeding from the illustrated prior art, the invention is based on the object of further developing a load torque lock such that the mechanical load on the driver during the introduction of a locking torque is reduced. In particular, the bending load on the driver pins is intended to be reduced. The invention is thus based on the concept of forming the driver in two parts, such that the contact region of the driver, which interacts with the wrap element, is arranged in the plane of the wrap element on a first driver element which interacts with a second driver element arranged above the drive wheel. As a result, the driver pins can be formed to connect the two driver elements, thereby enabling a large-area connection which reduces the bending load in the driver pins.

In a preferred embodiment of the invention, it is proposed that the second driver element is radially mounted in a housing element on that side of the drive wheel that is remote from the first driver element and/or on the drive wheel. As a result, a radial orientation of the second driver element with respect to the first driver elements is achieved with relatively little effort and the function of the radial guidance of the second driver elements is separated from the connection with the first driver element.

In order to realize a defined position of the two driver elements with respect to each other, said defined position furthermore avoiding incorrect positioning during assembly, it is furthermore proposed that the second driver element has at least one, in particular pocket-shaped recess for receiving the at least one driver pin in a form-fitting manner.

In this case, a particularly secure and firm connection between the two driver elements is enabled when the driver pin that interacts with the recess is formed in a longitudinally slotted manner in the axial direction, and when a press fit is formed between the driver pin and the recess. In particular, component tolerances between the recess and the driver pin can be compensated easily on account of the longitudinally slotted formation of the driver pin.

In order to be able to structurally design the contact region with the braking element optimally and to separate it from the mounting of the driver pin, it is furthermore proposed that the contact region with the braking element is formed on the second driver element as at least one in particular rib-shaped integral formation, and that the integral formation is arranged in a radially offset manner with respect to the at least one driver pin.

In this case, it is particularly preferred that the integral formation is connected to a protective element which interacts directly with the braking element. By way of such a protective element, in particular the wear on the contact surface of the second driver element is lowered and the second driver element can be adapted optimally to the transmission of a torque to the braking element.

Therefore, in a particularly preferred variant of this embodiment, it is proposed that at least the second driver element is formed from plastics material, and that the protective element consists of harder material than the second driver element, in particular of metal.

Particularly high operational reliability of the load torque lock by guidance of the braking element formed in particular as a wrap spring is brought about when the second driver element has at least one holding-down means integrally formed, in particular in one piece, on the second driver element, said holding-down means covering the braking element on the side facing the drive wheel. Thus, in particular contact between the wrap spring and the drive wheel, which could otherwise lead to blocking of the drive wheel, is avoided.

In order to avoid uncontrolled movements of the driver or of the braking element, said movements being associated with noise, it is furthermore proposed in a further embodiment of the invention that the drive wheel has at least one friction surface on the side facing the second driver element, said at least one friction surface increasing the friction between the drive wheel and the braking element and between the drive wheel and the lower driver element.

The invention also comprises a unit, in particular for motor vehicle applications, having a load torque lock according to the invention. Such a unit allows the transmission of relatively high torques, in particular in the locking direction, with a relatively small structure.

### BRIEF DESCRIPTION OF THE DRAWINGS

Further advantages, features and details of the invention will become apparent from the following description of preferred exemplary embodiments and with reference to the drawings, in which:

FIG. 1 shows a perspective view of a partially opened unit having a load torque lock according to the invention,

FIG. 2 shows an exploded illustration of the essential constituent parts of a load torque lock according to the invention,

FIG. 3 shows a perspective view of a partially assembled load torque lock without a drive wheel and upper driver element,

FIG. 4 shows the arrangement according to FIG. 3 with assembled drive wheel, likewise in a perspective illustration,

FIG. 5 shows the arrangement according to FIG. 3 with assembled upper driver element, but without a drive wheel, likewise in a perspective illustration, and

FIG. 6 shows a bottom view of the drive wheel.

### DETAILED DESCRIPTION

Identical components or components having the same function are provided with identical reference numbers in the figures.

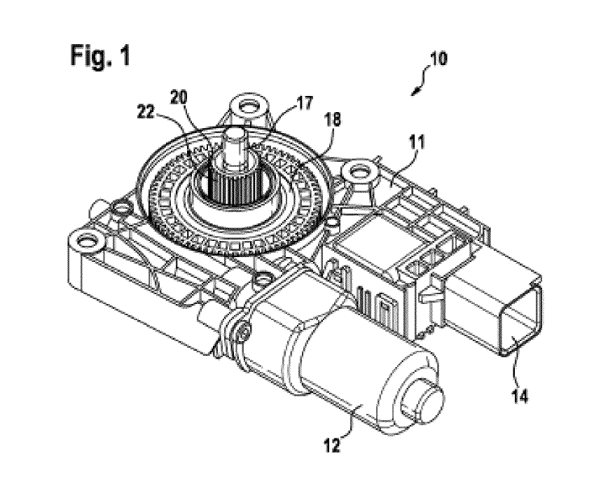

FIG. 1 illustrates a unit 10 for motor vehicle applications in the form of a window opener drive. Instead of a window opener drive, it is also within the scope of the invention for the unit 10 to be in the form of a motor, machine, adjustment drive, sliding-roof drive, electric motor vehicle steering system or the like. In the exemplary embodiment, the unit 10 has a housing 11 produced from a plurality of parts by an injection-molding process or metal die casting process. Flange-mounted laterally on the housing 11 is a drive motor 12, which is in the form of an electric motor. Integrated in the housing 11 laterally next to the drive motor 12 are control electronics (not illustrated) which can be connected for example to the cable harness of the motor vehicle via a plug connection 14. The required energy for the drive motor 12 is also introduced into the unit 10 via the plug connection 14.

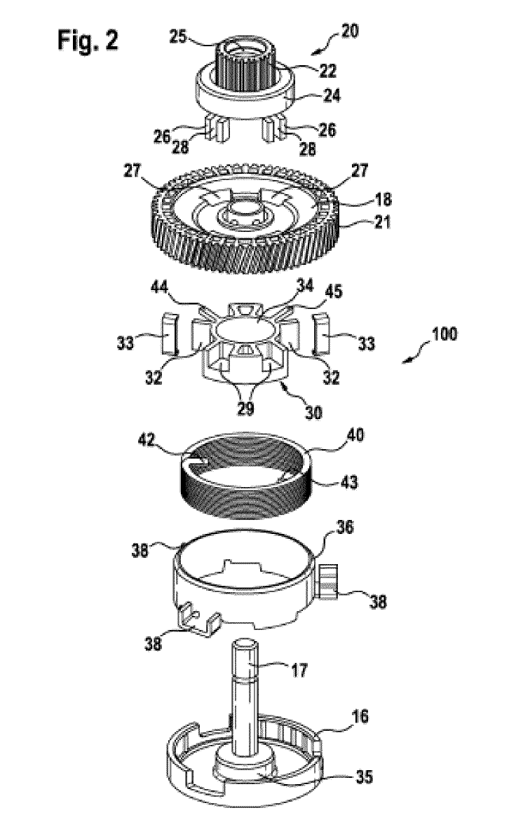

Arranged in the housing 11 is a pot-shaped housing shell 16 which can be seen in FIG. 2. An axle stub 17 is pressed in a bore into the housing shell 16, which consists in particular of plastics material, said axle stub 17 serving to mount a drive wheel 18 and a driver 20. In this case, the drive wheel 18 has a drive toothing formed in particular as a helical toothing 21, which meshes with a toothing which is not discernible in the figures and is arranged on a driveshaft (likewise not discernible) of the drive motor 12. A drive torque introduced into the drive wheel 18 via the drive motor 12 is transmitted via the driver 20, which has to this end a toothing 22 which interacts in a form-fitting manner in particular with a counterpart toothing on an element (not shown) of a window opener mechanism. To this end, the element is pushed axially, by way of its counterpart toothing, onto the toothing 22. Thus, via the toothing 22, the torque introduced by the drive motor 12 can be transmitted to the window opener mechanism which is arranged in operative connection with the unit 10 and serves to raise and lower a window pane.

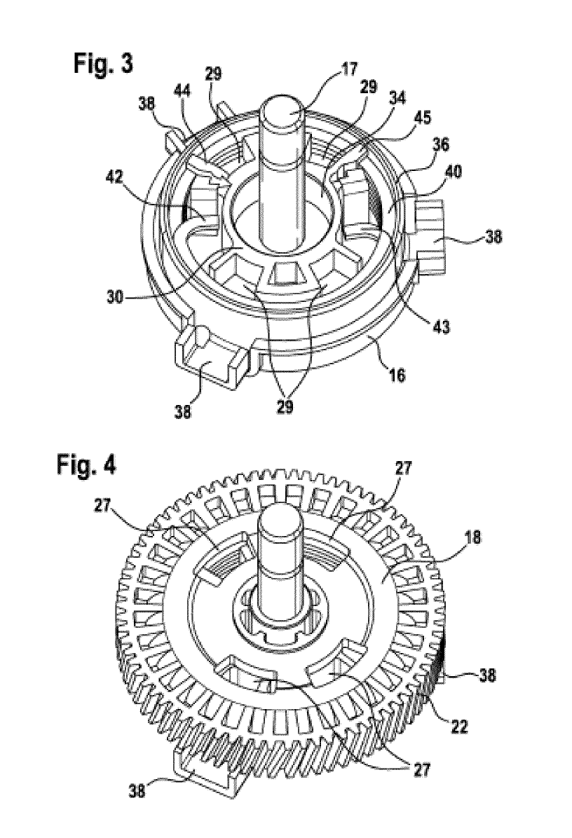

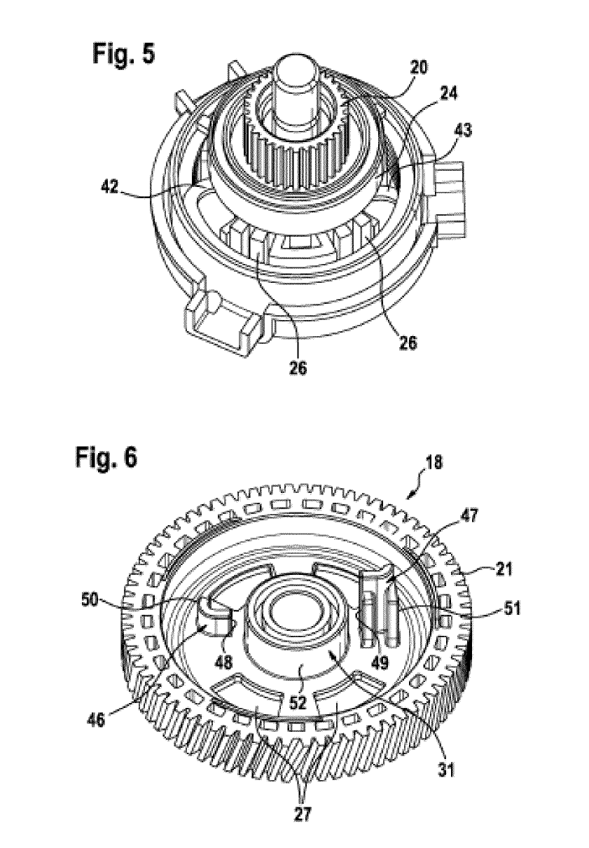

As can be seen in particular from viewing FIGS. 2 to 5 together, the driver is configured in two parts 20. In this case, the driver 20 has an upper or first driver element 24 which also carries the outer toothing 22. The first driver element 24 is mounted rotatably on the axle stub 17 via a through-passage bore 25 (optionally by way of a bearing arranged therein). Arranged on the underside of the first driver element 24 are four driver pins 26, which are preferably integrally formed in one piece on the first driver element 24 which consists of plastics material. The driver pins 26 engage through the drive wheel 18, which, to this end, has four apertures 27 in the exemplary embodiment. It is still essential that the apertures 27 are dimensioned with respect to the driver pins 26 such that the driver pins 26 of the first driver element 24 are arranged with rotational angle play in the drive wheel 18 or the apertures 27.

The four driver pins 26 each have a continuous longitudinal slot 28 that extends in the radial direction. The driver pins 26 engage underneath the drive wheel 18 in a form-fitting manner into pocket-shaped recesses 29 in a lower, second driver element 30. The lower (second) driver element 30 is produced preferably likewise from plastics material in an injection-molding process. The driver pins 26 are dimensioned with respect to the pocket-shaped recesses 29 such that the driver pins 26 are optionally slightly deformed on being pushed into the recesses 29, this being allowed by the longitudinal slots 28. Thus, during the connection of the two driver elements 24, 30 a press fit is formed between the upper (first) driver element 24 and the lower driver element 30.

The lower driver element 30 also has two transmission ribs 32 extending in the longitudinal direction over the entire height of the lower driver element 30, said transmission ribs 32 being arranged approximately opposite each other in the exemplary embodiment. The two transmission ribs 32 are each covered by a protective element that consists in particular of metal and is in the form of a protective cap 33. The protective cap 33 can in this case have been clipped onto the transmission rib 32 or be connected to the transmission rib 32 in some other way.

The lower driver element 30 is radially mounted via a radially encircling web-like collar 31 which is integrally formed in one piece on the underside of the drive wheel 18 and is discernible only in FIG. 6, said collar 31 engaging in a bore 34 in the lower driver element 30. Alternatively or in addition, the second driver element 30 is radially mounted via a bearing collar 35 integrally formed in the housing shell 16, said bearing collar 35 likewise engaging in the bore 34.

Arranged within the housing shell 16 is also a stationary brake drum 36 that consists in particular of sheet metal. For the fixed-torque arrangement of the brake drum 36 in the housing shell 16 or in the housing 11, the brake drum 36 has in the exemplary embodiment three radially outwardly protruding retaining lugs 38 which are arranged at a regular angular spacing from one another. The brake drum 36 is a constituent part of a load torque lock 100 according to the invention. The load torque lock 100 furthermore comprises a braking element in the form of a wrap spring 40, said braking element being arranged within the brake drum 36 at a small radial distance therefrom. In each case a spring end 42, 43 projects radially inwards from the two ends of the wrap spring 40. The two spring ends 42, 43 are each arranged in the immediate proximity of the transmission ribs 32 and the protective caps 33, respectively, and interact with the transmission ribs 32 during the introduction of a torque to be locked. The lower driver element 30 also has two radially outwardly projecting webs 44, 45 which act as a holding-down means for the wrap spring 40 and are integrally formed in one piece on the lower driver element 30, said webs 44, 45 being arranged close to the two transmission ribs 32. By way of the webs 44, 45, in particular contact between the wrap spring 40 and the drive wheel 18 can be avoided.

It can be seen from the bottom view of the drive wheel 18 illustrated in FIG. 6 that said drive wheel 18 has on its underside two friction webs 46, 47 which are integrally formed in one piece on the drive wheel 18 and have different heights. The friction webs 46, 47, which are each assigned to one of the spring ends 42, 43 of the wrap spring 40, have radial inner first friction surfaces 48, 49 and also radially outer second friction surfaces 50, 51. The first friction surfaces 48, 49 are arranged in operative connection with the lower driver element 30, in order to make it harder by friction for the latter to rotate. The outer surface 52 of the collar 31 can also be used for this purpose, said collar 31 likewise being arranged in friction-increasing operative connection with the bore 34 of the lower driver element 30. Furthermore, the two friction surfaces 50, 51 are arranged in operative connection with the inner circumference of the wrap spring 40, in order likewise to prevent the rotation thereof. Thus, the first and second friction surfaces 48 to 51 and also the outer surface 52 are used to prevent uncontrolled movements, associated with noise, of the wrap spring 40 and of the driver pins 26.

The mode of operation of the load torque lock 100 is as follows: When a drive torque is transmitted from the drive wheel 18 via the driver pins 26 to the upper driver element 24 of the driver 20, the wrap spring 40 is arranged in an unstressed manner within the brake drum 36 with slight radial play with respect to the latter, such that a drive torque can be transmitted. In the process, the wrap spring 40 rotates synchronously with the driver 20, wherein the transmission ribs 32 are arranged in operative connection with the spring ends 42, 43 such that the latter are rotated with respect to one another such that radial expansion of the wrap spring 40 does not take place. However, if a torque to be locked or blocked is transmitted to the load torque lock 100 in particular from the element to be adjusted (for example the window pane) via the upper driver element 24 of the driver 20, said load torque lock 100 is initially passed on to the lower driver element 30 via the driver pins 26. The lower driver element 30 is then rotated on account of the torque, with the transmission ribs 32 and the protective caps 33 coming into operative connection with the spring ends 42, 43 of the wrap spring 40 such that the transmission ribs 32 rotate the two spring ends 42, 43 with respect to one another, as a result of which the outside diameter of the wrap spring 40 increases, and so the outer circumference of the individual coils of the wrap spring 40 rests against the brake drum 36 and said coils block the torque introduced via the transmission ribs 32. As a result, the drive wheel 18 is prevented from rotating.

The load torque lock 100 described thus far can be modified in many different ways without departing from the scope of the invention. The latter consists in particular in the use of a two-part driver 20 that consists of an upper driver element 24 and a lower driver element 30, wherein the lower driver element 30 has transmission ribs 32 for transmitting a torque to be locked, said transmission ribs 32 being arranged in a manner spatially separated from the driver pin 26.

1. A load torque lock (100) having a braking element (40) that interacts frictionally with a braking body (36) in order to lock a torque, and also having a drive wheel (18) mounted rotatably, said drive wheel (18), in order to transmit a torque from a drive motor (12), being coupled to at least one driver (20) that interacts with the drive wheel (18), wherein the driver (20) has at least one contact region (32) with the braking element (40), by way of which a torque to be blocked is introducible into the braking body (36) via the braking element (40),
characterized
in that the driver (20) consists of a first driver element (24) and a second driver element (30) formed as a separate component, in that one of the first and the second driver element (24, 30) has at least one driver pin (26) which engages through an aperture (27) in the drive wheel (18), and in that the two driver elements (24, 30) are arranged on different sides of the drive wheel (18), with the exception of the at least one driver pin (26).

2. The load torque lock as claimed in claim 1, characterized in that the second driver element (30) is arranged within the braking element (40), and in that the contact region (32) with the braking element (40) is assigned to the second driver element (30), and in that the two driver elements (24, 30) are connected together.

3. The load torque lock as claimed in claim 1, characterized in that the second driver element (30) is radially mounted in a housing element (16) on at least one of a side of the drive wheel (18) that is remote from the first driver element (24) and the drive wheel (18).

4. The load torque lock as claimed in claim 1, characterized in that the second driver element (30) has at least one recess (29) for receiving the at least one driver pin (26) in a form-fitting manner.

5. The load torque lock as claimed in claim 1, characterized in that the driver pin (26) that interacts with the recess (29) is formed in a longitudinally slotted manner in an axial direction, and in that a press fit is formed between the driver pin (26) and the recess (29).

6. The load torque lock as claimed in claim 1, characterized in that the contact region with the braking element (40) is formed on the second driver element (30) as at least one integral formation (32), and in that the integral formation (32) is arranged in an offset manner with respect to the at least one driver pin (26).

7. The load torque lock as claimed in claim 6, characterized in that the integral formation (32) is connected to a protective element (33) which interacts directly with the braking element (40).

8. The load torque lock as claimed in claim 7, characterized in that at least the second driver element (30) is formed from plastics material, and in that the protective element (33) consists of harder material than the second driver element (30).

9. The load torque lock as claimed in claim 1, characterized in that the second driver element (30) has at least one holding-down means (44, 45) integrally formed on the second driver element (30), said holding-down means (44, 45) covering the braking element (40) on the side facing the drive wheel (18).

10. The load torque lock as claimed in claim 1, characterized in that the drive wheel (18) has at least one friction surface (48 to 52) on a side facing the second driver element (30), said at least one friction surface (48 to 52) increasing the friction between the drive wheel (18) and the braking element (40) and between the drive wheel (18) and the lower driver element (30).

11. A unit (10), for motor vehicle applications, having a load torque lock (100) as claimed in claim 1.

12. A load torque lock (100) having a braking element (40) that interacts frictionally with a braking body (36) in order to lock a torque and is formed as a wrap spring, and also having a drive wheel (18) mounted rotatably on an axle (17), said drive wheel (18), in order to transmit a torque from a drive motor (12), being coupled to at least one driver (20) that interacts with the drive wheel (18), wherein the driver (20) has at least one contact region (32) with the braking element (40), by way of which a torque to be blocked is introducible into the braking body (36) via the braking element (40), characterized in that the driver (20) consists of a first driver element (24) and a disk-shaped second driver element (30) formed as a separate component, in that one of the first and the second driver element (24, 30) has at least one driver pin (26) which engages through an aperture (27) in the drive wheel (18), and in that the two driver elements (24, 30) are arranged on different sides of the drive wheel (18), with the exception of the at least one driver pin (26).

13. The load torque lock as claimed in claim 1, characterized in that the second driver element (30) has at least one pocket-shaped recess (29) for receiving the at least one driver pin (26) in a form-fitting manner.

14. The load torque lock as claimed in claim 1, characterized in that the contact region with the braking element (40) is formed on the second driver element (30) as at least one rib-shaped integral formation (32), and in that the integral formation (32) is arranged in a tangentially offset manner with respect to the at least one driver pin (26).

15. The load torque lock as claimed in claim 7, characterized in that at least the second driver element (30) is formed from plastics material, and in that the protective element (33) consists of a metal that is harder than the second driver element (30).

16. The load torque lock as claimed in claim 1, characterized in that the second driver element (30) has at least one holding-down means (44, 45) integrally formed in one piece on the second driver element (30), said holding-down means (44, 45) covering the braking element (40) on the side facing the drive wheel (18).
